(19) United States
(12) Patent Application Publication
(10) Pub. No.: US 2025/0196638 A1
(43) Pub. Date: Jun. 19, 2025

(54) VEHICLE AND CONTROL METHOD THEREOF

(71) Applicants: Hyundai Motor Company, Seoul (KR); Kia Corporation, Seoul (KR)

(72) Inventor: Jun Hyung Song, Hwaseong-si (KR)

(21) Appl. No.: 18/937,465

(22) Filed: Nov. 5, 2024

(30) Foreign Application Priority Data
Dec. 15, 2023 (KR) 10-2023-0183279

(51) Int. Cl. B60K 35/231; B60W 40/08; B60W 50/14

(52) U.S. Cl. CPC B60K 35/231; B60W 40/08; B60W 50/14; B60W 2050/146; B60W 2554/4041; B60W 2554/4042

(57) ABSTRACT

A vehicle can includes a sensor mounted in the vehicle, a display unit mounted in the vehicle, and a processor configured to control the sensor and the display unit. A combination of the processor, the sensor, and the display unit can be configured to sense driving information of the vehicle that is traveling and surrounding information about the surroundings of the vehicle, collect the sensed driving information of the vehicle and the sensed surrounding information of the vehicle, and select a target object among a plurality of objects present before the vehicle based on the sensed information, collect target information related to the target object, and set a target area based on the collected target information, and match the target object to the set target area, and project an indicator relating to the target object onto a windshield of the vehicle.

### CROSS-REFERENCE TO RELATED APPLICATIONS

This application claims the benefit of Korean Patent Application No. 10-2023-0183279, filed on Dec. 15, 2023, which is hereby incorporated by reference as if fully set forth herein.

### TECHNICAL FIELD

The present disclosure relates to a vehicle and a control method thereof.

### BACKGROUND

A forward collision-avoidance assist (FCA) function may be intended to provide a visual, audible, and tactile warning to drivers in case of a risk of collision such that the driver recognizes such a dangerous situation.

For example, the FCA function using a forward-facing camera sensor has limitations in that it recognizes a target only when the target is visible and may thus fail to provide accurate information about a target posing a potential risk of collision.

Accordingly, the driver may not be aware of an object that is a target of FCA warning/control, which may increase the likelihood of inadequate response to a situation with a risk of collision or incorrect braking or steering control by the driver.

### SUMMARY

An embodiment of the present disclosure can provide a vehicle (e.g., an autonomous vehicle) and a control method thereof that, when a forward collision-avoidance assist (FCA) function performs warning and control in a situation with a risk of collision, may warn a driver of a risk warning target by specifying an area on a windshield with a laser beam for the risk warning target such that the driver is able to intuitively recognize such a risk target and respond to the risk of collision.

An embodiment of the present disclosure can provide a vehicle (e.g., an autonomous vehicle) and a control method thereof that may recognize and calculate longitudinal/lateral relative positions of the vehicle and a target vehicle using sensor information detected by an autonomous driving sensor (e.g., a front camera, a front radar, a front/side (or blind spot) radar, etc.), and display an area on actually visible borders of the target vehicle and a target object, through a windshield, to allow a driver to recognize this quickly and easily.

The technical advantages to be achieved by an embodiment of the present disclosure are not necessarily limited to those described above, and other technical advantages not described above may also be understood by those skilled in the art from the following description.

To solve the preceding technical problems, according to an embodiment of the present disclosure, in a method of controlling a vehicle including a processor, the method can include sensing, by at least one sensor, driving information of the vehicle and surrounding information about surroundings of the vehicle, collecting, by the processor, the sensed driving information and the sensed surrounding information to select, as a target object, at least one among a plurality of objects present before the vehicle, collecting, by the processor, at least one set of target information related to the selected target object to set a target area on a windshield of the vehicle, and projecting an indicator for the target object in the target area of the windshield of the vehicle.

The target information may include position information about longitudinal and lateral positions of the target object, and size information of the target object.

The vehicle may further include: a display unit that includes an auxiliary display unit including at least one light-emitting diode (LED) or laser beam on a front surface; an operation unit disposed under the auxiliary display unit and configured to control an angle of the auxiliary display unit; and an internal sensor disposed on a rear surface of the display unit or in the operation unit and configured to sense the eyes of a driver aboard the vehicle. The auxiliary display unit may be disposed with a front surface thereof facing the windshield, and can be disposed in a parallel direction with respect to the windshield with a constant distance therebetween.

The projecting of the indicator may include sensing, by the processor, the eyes of the driver using the internal sensor, and predicting, by the processor, a gaze of the driver based on the sensed eyes of the driver, and projecting the indicator in the target area of the windshield based on the predicted gaze of the driver.

The method may further include projecting an arrow or point at a left or right end area of the windshield for a target object determined as being located out of a preset boundary for the windshield and approaching to the vehicle.

The projecting of the indicator may include projecting the indicator in a color determined based on a speed of the target object.

The method may further include displaying a warning mark image within the target area.

To solve the preceding technical problems, an embodiment of the present disclosure can include a non-transitory computer-readable recording medium storing a program for executing the method of controlling the vehicle.

To solve the preceding technical problems, according to an embodiment of the present disclosure, a vehicle can include a sensor mounted in the vehicle, a display unit mounted in the vehicle, and a processor configured to control the sensor and the display unit, where the processor is configured to sense driving information of the vehicle and surrounding information about the surroundings of the vehicle using the sensor, collect the sensed driving information and the sensed surrounding information, and select, as a target object, at least one among a plurality of objects present before the vehicle based on the sensed driving and surrounding information, collect at least one set of target information related to the selected target object, and set a target area on a windshield of the vehicle based on the collected target information, and project an indicator for the target object in the target area of a windshield of the vehicle.

The target information may include position information about longitudinal and lateral positions of the target object, and size information of the target object.

The display unit may include: an auxiliary display unit including at least one LED or laser beam on a front surface; an operation unit disposed under the auxiliary display unit and configured to control an angle of the auxiliary display unit; and an internal sensor disposed on a rear surface of the display unit or in the operation unit and configured to sense the eyes of a driver.

The auxiliary display unit may be disposed with a front surface thereof facing the windshield, and can be disposed in a parallel direction with respect to the windshield with a constant distance therebetween.

The processor may be configured to sense the eyes of the driver using the internal sensor, predict a gaze of the driver based on the sensed eyes of the driver, and project the indicator in the target area of the windshield of the vehicle.

The processor may be configured to project an arrow or point at a left and right end area of the windshield for a target object determined as being located out of a preset boundary for the windshield and approaching to the vehicle.

The processor may be configured to project the indicator in a color determined based on a speed of the target object.

The processor may be configured to display a warning mark image within the target area.

The vehicle and the control method configured as described above according to embodiments of the present disclosure may allow a driver to intuitively and quickly recognize a risk target when there is a warning of a collision risk and respond to such a situation with the collision risk, thereby improving the safety of the driver.

The vehicle and the control method configured as described above according to embodiments of the present disclosure may intuitively display, in a field of view (FOV) of a driver, a warning matched to an actual target object, and may thus increase the effects of the warning, thereby reducing an accident risk.

The vehicle and the control method configured as described above according to embodiments of the present disclosure may warn a driver of a target object approaching from the outside of a windshield (or a FOV of the driver) by recognizing in advance an orientation of the target object and may allow the driver to prepare for such a situation with a collision risk, thereby improving the reliability of driving or autonomous driving.

Alternatively, the vehicle and the control method configured as described above according to embodiments of the present disclosure may allow a driver to intuitively recognize a target object through a windshield, thereby preventing a safety accident.

The advantages that can be achieved from an embodiment of the present disclosure are not necessarily limited to those described above, and other advantages not described above may also be clearly understood by those skilled in the art from the following description.

### BRIEF DESCRIPTION OF THE DRAWINGS

FIG. 1 is a block diagram illustrating a vehicle according to an embodiment of the present disclosure.

FIG. 2 is a block diagram illustrating a display unit of FIG. 1 according to an embodiment of the present disclosure.

FIG. 3A and FIG. 3B are diagrams illustrating in detail the display unit of FIG. 2 according to an embodiment of the present disclosure.

FIG. 4A, FIG. 4B, FIG. 5A and FIG. 5B are diagrams illustrating examples of a target area projected on a windshield according to an embodiment of the present disclosure.

FIG. 6 is a flowchart illustrating a method of controlling a vehicle according to an embodiment of the present disclosure.

### DETAILED DESCRIPTION OF ILLUSTRATIVE EMBODIMENTS

Hereinafter, example embodiments of the present disclosure will be described in detail with reference to the accompanying drawings, and same or similar elements can be given same reference numerals regardless of reference symbols, and a repeated description thereof can be omitted. Further, when describing the example embodiments, when it is determined that a detailed description of related publicly known technology obscures the gist of the example embodiments described herein, the detailed description thereof can be omitted.

As used herein, the terms “include,” “comprise,” and “have” specify the presence of stated features, numbers, operations, elements, components, and/or combinations thereof, but do not preclude the presence or addition of one or more other features, numbers, operations, elements, components, and/or combinations thereof. In addition, when describing the embodiments with reference to the accompanying drawings, like reference numerals refer to like components and a repeated description related thereto will be omitted.

The terms “unit” and “control unit” included in names such as a vehicle control unit (VCU) may be terms widely used in the naming of a control device or controller configured to control vehicle-specific functions but may not be a term that represents a generic function unit. For example, each controller or control unit may include a communication device that communicates with other controllers or sensors to control a corresponding function, a memory that stores an operating system (OS) or logic commands and input/output information, and at least one vehicle controller that performs determination, calculation, selection, and the like necessary to control the function. The vehicle controller may also be referred to herein as a drive controller.

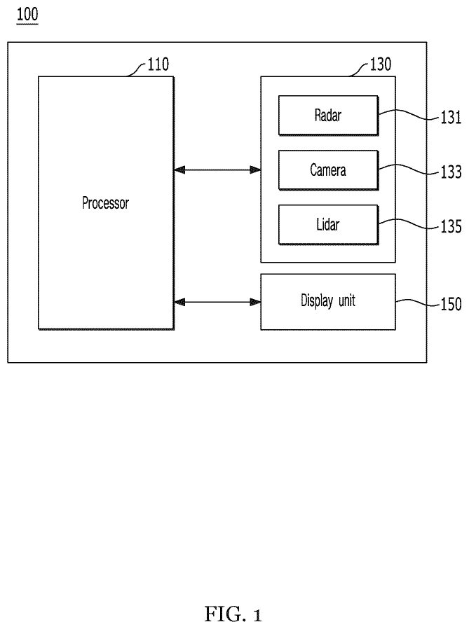

FIG. 1 is a block diagram illustrating a vehicle according to an embodiment of the present disclosure.

Referring to FIG. 1, according to an example embodiment, a vehicle 100 (e.g., an autonomous vehicle) may include a processor 110, a plurality of sensors 130, and a display unit 150.

The sensors 130 may be front sensors disposed in the front of the autonomous vehicle 100 and configured to sense forward surroundings. For example, the sensors 130 may include a radar 131, a camera 133, a lidar 135, or the like.

The radar 131 may be provided as one or more radars and mounted on the autonomous vehicle 100. The radar 131 may measure a relative speed and a relative distance with respect to a recognized object, in conjunction with a wheel speed sensor (not shown) mounted on the autonomous vehicle 100. For example, the radar 131 may be mounted in the front of the autonomous vehicle 100 to recognize an object present in front of the autonomous vehicle 100. The object described herein may refer to an obstacle, a vehicle, a person, a thing, or the like, present outside the autonomous vehicle 100.

The camera 133 may be provided as one or more cameras and mounted on the autonomous vehicle 100. The camera 133 may capture an image of an object or a state of the object present around the autonomous vehicle 100 and may output image data based on the captured information. For example, the camera 133 may be mounted on the autonomous vehicle 100 to recognize an object in front of the autonomous vehicle 100.

The lidar 135 may be provided as one or more lidars and mounted on the autonomous vehicle 100. The lidar 135 may irradiate a laser pulse to an object, measure a time at which the laser pulse reflected from the object within a measurement range returns, sense information such as a distance to the object, a direction of the object, a speed of the object, or the like, and output lidar data based on the sensed information.

The processor 110 may sense driving information of the autonomous vehicle 100 that is currently traveling and surrounding information about the surroundings of the autonomous vehicle 100, collect the sensed driving information of the autonomous vehicle 100 and the sensed surrounding information of the autonomous vehicle 100, and select at least one object from among a plurality of objects present in front of the autonomous vehicle 100 as a target object based on the sensed information. That is, the processor 110 may receive the driving information of the autonomous vehicle 100 and the surrounding information of the autonomous vehicle 100 through the sensors 130 described above, and may analyze the received driving information of the autonomous vehicle 100 and the received surrounding information of the autonomous vehicle 100 to recognize one or more objects present in front of the autonomous vehicle 100.

The processor 110 may extract an object that satisfies a preset target range from among the one or more objects and select the extracted object as a target object. The target object described herein may be one or more objects.

The processor 110 may collect at least one target information associated with the selected target object and may set a target area based on the collected target information. The target information may include position information associated with longitudinal/lateral positions of the target object, size information of the target object, or the like.

For example, the processor 110 may collect the position information about the longitudinal/lateral positions of the target object, the size information of the target object, and the like, and set a target area that may include the target object based on the collected information. For example, the target area may be set based on a position of the target object, an angle of the target object, and an outline point of the target object (or a border line of the target object).

Once the target area is set, the processor 110 may provide information about the target area and information about the target object to the display unit 150.

The processor 110 may match the target object to the set target area and project it onto a windshield of the autonomous vehicle 100.

The display unit 150 may receive the information about the target area and the information about the target object and project it onto the windshield of the autonomous vehicle 100, under the control of the processor 110. The display unit 150 may match the target object moving in real time to the target area and project it onto the windshield of the autonomous vehicle 100, under the control of the processor 110.

The display unit 150 may project a warning mark image and the like, in addition to various information about the target object, onto the target area that is projected on the windshield of the autonomous vehicle 100, under the control of the processor 110. This will be described in more detail below.

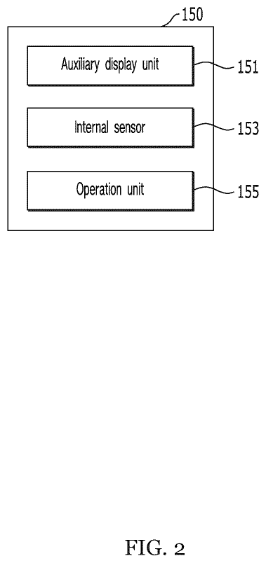

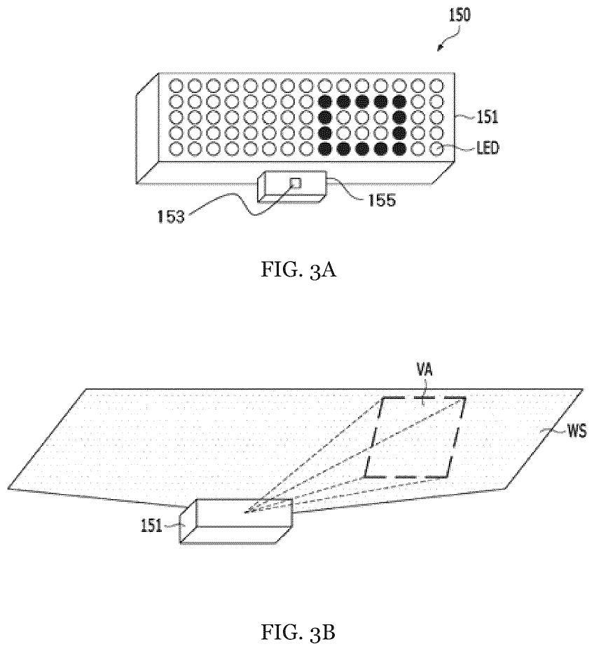

FIG. 2 is a block diagram illustrating the display unit of FIG. 1, and FIGS. 3A and 3B are diagrams illustrating in detail the display unit of FIG. 2.

Referring to FIG. 2, FIG. 3A, and FIG. 3B, according to an embodiment of the present disclosure, the display unit 150 may include an auxiliary display unit 151, an internal sensor 153, and an operation unit 155.

The auxiliary display unit 151 may include, on a front surface, at least one light-emitting diode (LED) or laser beam. The auxiliary display unit 151 may be disposed around a cluster of the autonomous vehicle 100.

The front surface of the auxiliary display unit 151 may be disposed to face a windshield WS of the autonomous vehicle 100.

The auxiliary display unit 151 may project an indicator for a target object, wherein the indicator may include point or line image indicating a target area VA onto the windshield WS of the autonomous vehicle 100 by outputting the at least one LED or laser beam toward the windshield WS of the autonomous vehicle 100, under the control of the processor 110, as shown in FIG. 3B.

The internal sensor 153 may be disposed at the rear of the auxiliary display unit 151 or near the operation unit 155 (refer to FIG. 3A). However, examples are not necessarily limited thereto.

The internal sensor 153 may perform sensing a gaze of the driver based on a result of sensing a face of the driver, under the control of the processor 110. For example, the internal sensor 153 may sense the pupils of the driver by performing sensing the eyes of the driver, under the control of the processor 110. The processor 110 may predict the position, angle, and gaze of the eyes of the driver based on the pupil of the driver recognized by the internal sensor 153.

The operation unit 155 may be disposed under the auxiliary display unit 151. The operation unit 155 may include a motor. The operation unit 155 may angle the auxiliary display unit 151 upward, downward, leftward, or rightward, using the motor, under the control of the processor 110.

For example, the operation unit 155 may operate based on the pupils of the user sensed by the internal sensor 153, under the control of the processor 110. Accordingly, the auxiliary display unit 151 may change the angle to face substantially the same direction as the pupils of the driver, under the control of the operation unit 155.

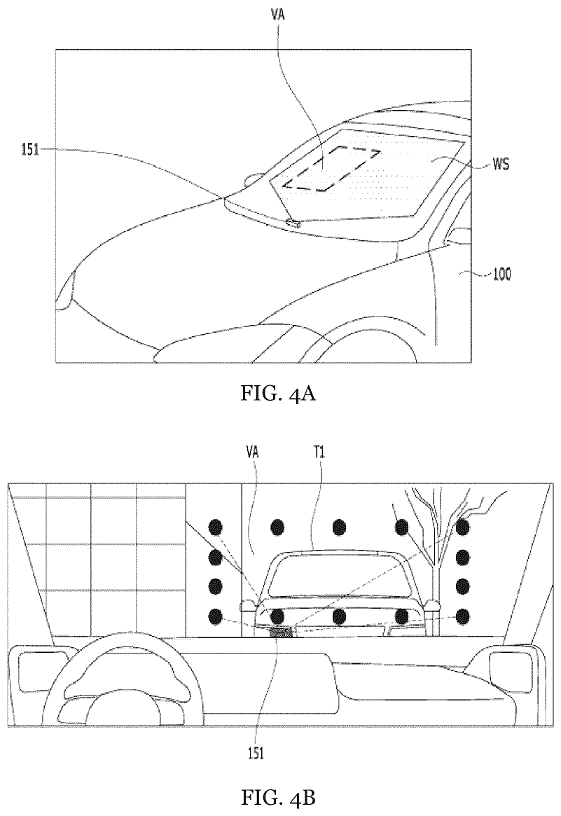

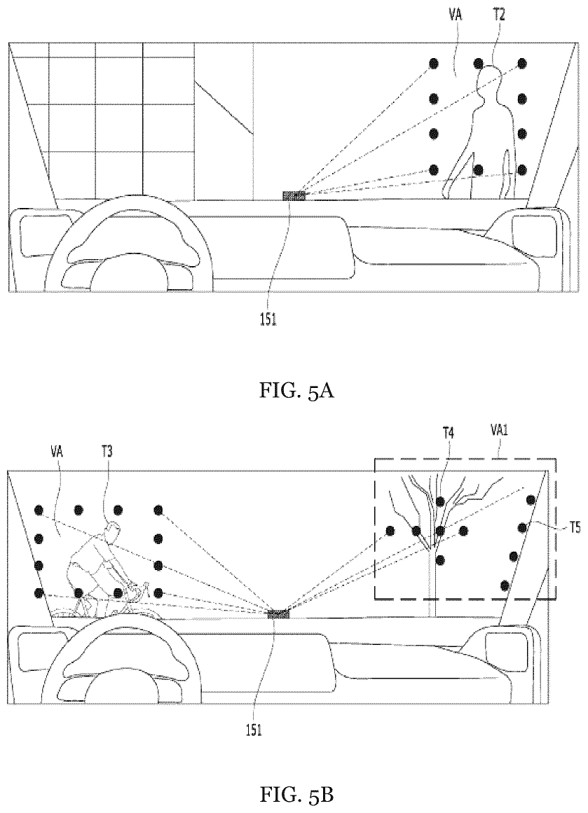

FIGS. 4A to 5B are diagrams illustrating examples of a target area VA projected on a windshield WS, according to an embodiment of the present disclosure.

Referring to FIG. 4A, the auxiliary display unit 151 may be disposed under a windshield WS of the autonomous vehicle 100.

The auxiliary display unit 151 may project a target area VA on the windshield WS of the autonomous vehicle 100 by outputting at least one LED or laser beam or the like toward the windshield WS of the autonomous vehicle 100, under the control of the processor 110.

The auxiliary display unit 151 may display a visual warning on the windshield WS based on a distance to an actual target or target object from an eye position of the driver, under the control of the processor 110, as shown in FIG. 4A.

The auxiliary display unit 151 may be disposed to be substantially parallel to the windshield WS, i.e., the angle of the laser beam may be disposed to be substantially parallel to the windshield WS. Thus, the laser beam may not be directed into the eyes of the driver. This disposition may prevent the driver from being distracted by the laser beam or the auxiliary display unit 151 while driving.

As described above, the laser beam, which can be from the auxiliary display unit 151 disposed below the center of the windshield WS, can be displayed in an upward direction, thereby preventing the view of the driver from being distracted and preventing nearby vehicles from being distracted during driving.

Referring to FIG. 4B, the processor 110 may sense driving information of the autonomous vehicle 100 that is currently traveling and surrounding information of the autonomous vehicle 100, through sensors (e.g., a camera, a radar, etc.), and collect the sensed driving information of the autonomous vehicle 100 and the sensed surrounding information of the autonomous vehicle 100 to recognize and calculate longitudinal and lateral relative positions of nearby stationary or moving objects around the autonomous vehicle 100 and the size of a target object T1 based on this information.

In a case in which a collision risk situation where there is a risk of collision with the calculated target object T1 occurs, the processor 110 may allow a forward collision-avoidance assist (FCA) warning and braking function to be activated. The processor 110 may project the target area VA onto the windshield WS using the laser beam at an actual position of the target object T1 such that the driver may intuitively and quickly recognize, as a target of warnings and control, the target object T1 that comes into a field of view (FOV) of the driver.

The processor 110 may project the target area VA, which can be an area displayed by the auxiliary display unit 151, in which the target object T1 can be visible to the driver through the windshield WS, by correcting the FOV of the driver, the windshield WS, the angle and position of the target object T1, and the like.

The processor 110 may control the auxiliary display unit 151 to project the target area VA onto the windshield WS and define the target area VA as a border around the target object T1.

For example, the processor 110 may control the auxiliary display unit 151 to change the target area VA as shown in FIG. 4B in a case where a target object is a front vehicle T1 and change the target area VA as shown in FIG. 5A in a case where a target object is a pedestrian T2, based on a display position and size of the target object (e.g., T1 and T2).

While controlling the auxiliary display unit 151, the processor 110 may analyze the position and angle of the eyes of the driver through the internal sensor 153, calculate the angle/size with respect to the position of the target object (e.g., T1 and T2) based on the analyzed position and angle of the eyes of the driver, and display it on the border of the target area VA projected on the windshield WS.

The internal sensor 153 may be an in-cabin camera (ICC), but examples of which are not limited thereto, and any sensors that may recognize the eyes or pupils of the driver may be used.

The processor 110 may configure the laser beam, which can be from the auxiliary display unit 151, with a plurality of small light sources (beams) to connect, by points, the border of the target object (e.g., T1 and T2) to display the target area VA. The processor 110 may adjust the position and size of the target area VA based on the relative movement, position, and the like between the autonomous vehicle 100 and the target object (e.g., T1 and T2).

For example, the auxiliary display unit 151 may change the size and position of the target area VA by turning on or turning off the plurality of light sources of the laser beam, under the control of the processor 110.

Referring to FIG. 5B, in a case where a target object T5 is sensed and recognized as being located outside a preset boundary for the windshield WS and approaching to the vehicle, the processor 110 may control the auxiliary display unit 151 to display arrows or points at a left and right end area of the windshield WS to warn of the object T5 with the direction and the like.

For example, a bicycle or motorcycle, which is a target object T3, may approach the autonomous vehicle 100 at a high speed from a lateral direction of the autonomous vehicle 100, and the FCA function may provide a warning and control braking before a collision. For example, at the time of the warning of the FCA function, the target object T5 may be left/right outside of the FOV (e.g., the windshield WS) of the driver.

In contrast, a tree, which is depicted as a target object T4 in FIG. 5B, may approach the autonomous vehicle 100 at a slow speed from a longitudinal direction of the autonomous vehicle 100, and in such case, can warn and provide braking control performed by the FCA function before a potential collision may allow the target object T4 to be within the FOV (e.g., the windshield) of the driver at the time of warning from the FCA function.

Accordingly, the processor 110 may control the auxiliary display unit 151 to visually display the direction of the target object T5 located outside the windshield WS at the left and right ends of the windshield WS, such that the driver may intuitively recognize the target object T5 as a collision risk target in a situation where the driver is not able to check the target object T5 that is a target of warning from the FCA function.

The processor 110 may control the auxiliary display unit 151 to visually display the direction of the target object T5 located outside the windshield WS at the left and right ends of the windshield WS, such that the driver may easily recognize the direction of the target object T5 and be warned of a danger of the target object T5 in advance.

As described above, the processor 110 may control the auxiliary display unit 151 to visually display a warning mark image through the target area VA projected on the windshield WS.

The processor 110 may control the auxiliary display unit 151 to display a target object on the windshield WS, but by varying colors depending on a speed at which the target object is moving, to provide the driver with information about the speed of the target object in advance based on a displayed color.

For example, the color depending on the speed of the target object may be defined as follows.

The target object may be displayed in yellow when the speed of the target object is between 8 and 10 kilometers per hour (km/h) and in red when the speed of the target object is between 10 and 15 km/h, and may flash in red when the speed of the target object is greater than 15 km/h. However, examples are not limited thereto, and the color may be changed to other various colors by the driver, for example.

The processor 110 may also control the auxiliary display unit 151 to change the color differently depending on the speed of the target object, and may also control the auxiliary display unit 151 to change the color of the target area VA along with the speed of the target object.

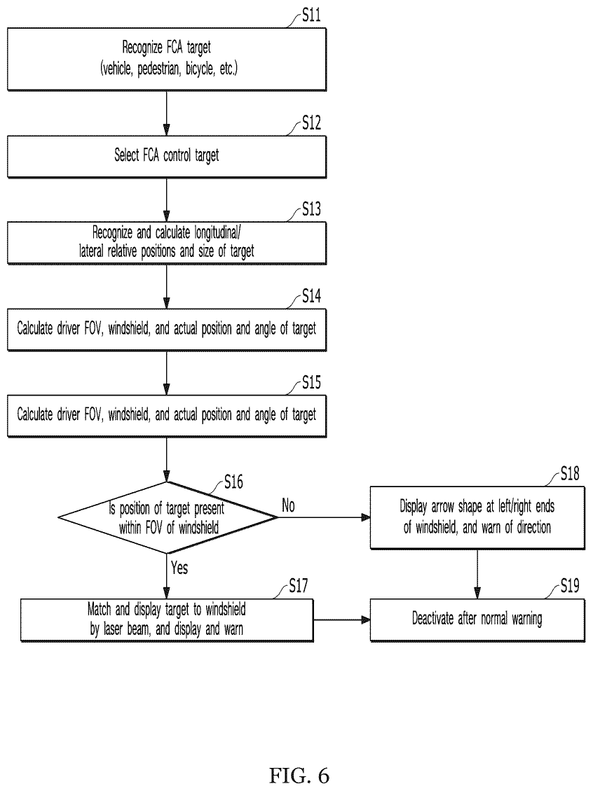

FIG. 6 is a flowchart illustrating a method of controlling an autonomous vehicle according to an embodiment of the present disclosure.

Referring to FIG. 6, according to an embodiment of the present disclosure, a method of controlling the autonomous vehicle 100 can be as follows.

In operation S11, under the control of the processor 110, the autonomous vehicle 100 may sense driving information of the autonomous vehicle 100 and surrounding information about the surroundings of the autonomous vehicle 100 while driving, and may collect the sensed driving information of the autonomous vehicle 100 and the sensed surrounding information of the autonomous vehicle 100 to recognize a plurality of objects present in front of the autonomous vehicle 100 based on the collected information.

The plurality of objects may include, for example, front vehicles, nearby vehicles, pedestrians, bicycles, or motorcycles.

Under the control of the processor 110, the autonomous vehicle 100 may receive the driving information of the autonomous vehicle 100 and the surrounding information of the autonomous vehicle 100 while driving via the sensors 130 described above, and analyze the received driving information of the autonomous vehicle 100 and the received surrounding information of the autonomous vehicle 100 to recognize at least one object present in front of the autonomous vehicle 100.

In operation S12, under the control of the processor 110, the autonomous vehicle 100 may recognize the plurality of objects in front of the autonomous vehicle 100 and select at least one target object from among the recognized plurality of objects.

For example, under the control of the processor 110, the autonomous vehicle 100 may extract an object that satisfies a preset target range from among the at least one object and select the extracted object as the target object. There may be one or more target objects.

In operation S13, under the control of the processor 110, the autonomous vehicle 100 may collect and calculate at least one target information associated with the selected target object. The target information may include position information about longitudinal and lateral positions of the target object, size information about the target object, and the like, for example.

In operation S14, under the control of the processor 110, the autonomous vehicle 100 may collect and calculate the at least one target information associated with the selected target object and may set a target area VA based on the calculated target information. For example, under the control of the processor 110, the autonomous vehicle 100 may set the target area VA based on a FOV of the driver, a windshield, an actual position and angle of the target object, and the like, with respect to the selected target object.

For example, under the control of the processor 110, the autonomous vehicle 100 may collect the position information about the longitudinal and lateral positions of the target object, the size information of the target object, and the like, and set the target area VA including the target object based on the collected information. For example, the target area VA may be set based on the FOV of the driver, the windshield, the actual position and angle of the target object, outline points of the target object (or a border line of the target object), and the like.

When the target area VA is set, the autonomous vehicle 100 may provide the display unit 150 with information about the target area VA and information about the target object, under the control of the processor 110.

In operation S15, under the control of the processor 110, the autonomous vehicle 100 may calculate a warning area display position or correct the target area VA, based on the information about the target area VA and the information about the target object.

In operation S16, under the control of the processor 110, the autonomous vehicle 100 may then determine whether the target object is included in the windshield WS.

In operation S17, when the target object is included in the windshield WS, the autonomous vehicle 100 may match the target object to the set target area VA and project the target object onto the windshield WS of the autonomous vehicle 100, under the control of the processor 110. Under the control of the processor 110, the autonomous vehicle 100 may project a display warning and the like within a range where the target area VA and the target object do not overlap.

Alternatively, in operation S18, when the target object is not included in the windshield WS, the autonomous vehicle 100 may be controlled to project the set target area VA in the shape of an arrow or point or the like on a left and/or right end of the windshield WS of the autonomous vehicle 100, under the control of the processor 110. Under the control of the processor 110, the autonomous vehicle 100 may project a warning mark image, such as a direction, using the shape of an arrow or point or the like.

In operation S19, under the control of the processor 110, the autonomous vehicle 100 may then deactivate an operation after the normal warning.

According to embodiments of the present disclosure, the autonomous vehicle 100 and the control method may intuitively display an actual target object in a FOV of the driver to match them, thereby enhancing the effectiveness of a warning and reducing the risk of accidents.

According to embodiments of the present disclosure, the autonomous vehicle 100 and the control method may recognize in advance the direction of a target object approaching from outside the windshield WS (outside the FOV of the driver) and provide a warning thereof to allow the driver to prepare for a situation with a potential collision risk, thereby improving the stability of autonomous driving or driving.

According to embodiments of the present disclosure, the autonomous vehicle and the control method may intuitively recognize a target object through the windshield, thereby preventing a safety accident.

The example embodiments of the present disclosure described herein may be implemented as computer-readable code on a medium in which a program is recorded. The computer-readable medium may include all types of recording devices that store data to be read by a computer system. The computer-readable medium may include, for example, a hard disk drive (HDD), a solid-state drive (SSD), a silicon disk drive (SDD), a read-only memory (ROM), a random-access memory (RAM), a compact disc ROM (CD-ROM), a magnetic tape, a floppy disk, an optical data storage device, and the like, for example.

Accordingly, the preceding detailed description should not be construed as restrictive but as illustrative in all respects. The scope of the embodiments of the present disclosure should be determined by reasonable interpretation of the appended claims, and all changes and modifications within the equivalent scope of the present disclosure are included in the scope of the present disclosure.

What is claimed is:

1. A method of driver assistance for controlling a vehicle, wherein the vehicle comprises a processor, at least one sensor, and a display unit, the method comprising:
sensing, by the at least one sensor, driving information of the vehicle and surrounding information about surroundings of the vehicle;
collecting, by the processor, the sensed driving information and the sensed surrounding information to select a target object among a plurality of objects present before the vehicle;
collecting, by the processor, target information related to the target object to set a target area on a windshield of the vehicle; and
projecting, by the display unit, an indicator for the target object in the target area of the windshield of the vehicle.

2. The method of claim 1, wherein the target information comprises:
position information about longitudinal and lateral positions of the target object; and
size information of the target object.

3. The method of claim 2, wherein the display unit comprises:
an auxiliary display unit comprising at least one light-emitting diode (LED) or laser device on a front surface thereof;
an operation unit disposed under the auxiliary display unit and configured to control an angle of the auxiliary display unit; and
an internal sensor disposed on a rear surface of the display unit or in the operation unit and configured to sense eyes of a driver of the vehicle, wherein the auxiliary display unit is disposed with the front surface thereof facing the windshield and in a parallel direction with respect to the windshield with a constant distance therebetween.

4. The method of claim 3, wherein the projecting of the indicator comprises:
sensing, by the internal sensor, the eyes of the driver using the internal sensor;
predicting, by the processor, a gaze of the driver based on the sensed eyes of the driver; and
projecting, by the auxiliary display unit, the indicator in the target area of the windshield based on the predicted gaze of the driver.

5. The method of claim 1, further comprising projecting an arrow or point at a left or right end area of the windshield in response to the target object being determined as being located out of a preset boundary for the windshield and approaching to the vehicle.

6. The method of claim 1, wherein the projecting of the indicator comprises projecting the indicator in a color determined based on a speed of the target object.

7. The method of claim 1, further comprising displaying a warning mark image within the target area.

8. A non-transitory computer-readable recording medium storing a program for executing the method according to claim 1.

9. A vehicle, comprising:
a sensor;
a display unit; and
a processor configured to control the sensor and the display unit, wherein a combination of the processor, the sensor, and the display unit is configured to:
sense driving information of the vehicle and surrounding information about the surroundings of the vehicle;
collect the sensed driving information and the sensed surrounding information, and select a target object one among a plurality of objects present before the vehicle based on the sensed driving information and the sensed surrounding information;
collect target information related to the target object;
set a target area on a windshield of the vehicle based on the target information; and
project an indicator for the target object in the target area of the windshield of the vehicle.

10. The vehicle of claim 9, wherein the target information comprises:
position information about longitudinal and lateral positions of the target object; and
size information of the target object.

11. The vehicle of claim 10, wherein the display unit comprises:
an auxiliary display unit comprising at least one light-emitting diode (LED) or laser device;
an operation unit configured to control an angle of the auxiliary display unit; and
an internal sensor configured to sense eyes of a driver.

12. The vehicle of claim 11, wherein the auxiliary display unit is disposed with a front surface thereof facing the windshield, and wherein the auxiliary display unit is disposed in a parallel direction with respect to the windshield with a constant distance therebetween.

13. The vehicle of claim 12, wherein the combination of the processor, the sensor, and the display unit is further configured to:
sense the eyes of the driver using the internal sensor;
predict a gaze of the driver based on the sensed eyes of the driver; and
adjust the target area based on the predicted gaze of the driver.

14. The vehicle of claim 9, wherein the combination of the processor, the sensor, and the display unit is configured to project an arrow or point at a left or right end area of the windshield in response to the target object being determined as being located out of a preset boundary for the windshield and approaching to the vehicle.

15. The vehicle of claim 9, wherein the combination of the processor, the sensor, and the display unit is further configured to project the indicator in a color determined based on a speed of the target object.

16. The vehicle of claim 9, wherein the combination of the processor, the sensor, and the display unit is further configured to display a warning mark image within the target area.

17. A method of driver assistance for a vehicle, the method comprising:
sensing driving information of the vehicle and surrounding information about surroundings of the vehicle;
selecting one or more target objects among a plurality of objects present before the vehicle based on the driving information and the surrounding information, and based on each of the one or more target objects being detected as a potential hazard for the vehicle;
for each of the one or more target objects, collecting target information related to the one or more target objects;
for each of the one or more target objects, setting a target area on a windshield of the vehicle; and
for each of the one or more target objects, projecting an indicator at the target area of the windshield of the vehicle.

18. The method of claim 17, further comprising:
sensing eyes of a driver;
predicting a gaze of the driver based on the sensing of the eyes of the driver; and
for each of the one or more target objects, adjusting the target area based on the predicted gaze of the driver.

19. The method of claim 17, further comprising, for a given target object of the one or more target objects, projecting the indicator at a left or right end area of the windshield in response to the given target object being located out of a boundary for the windshield and approaching toward the vehicle.

20. The method of claim 17, wherein for a given target object of the one or more target objects, the projecting of the indicator comprises projecting the indicator in a color determined based on a speed of the given target object.
